(19) United States
(12) Patent Application Publication
(10) Pub. No.: US 2008/0169774 A1
(43) Pub. Date: Jul. 17, 2008

(54) Integrated linear motor

(75) Inventors: Chi-Yuan Cheng, Taichung (TW); Ming-Hsing Liu, Taichung (TW)

Correspondence Address: CHARLES E. BAXLEY, ESQ., 90 JOHN STREET, THIRD FLOOR, NEW YORK, NY, 10038, US

(73) Assignee: Hiwin Mikrosystem Corp.

(21) Appl. No.: 11/654,208

(22) Filed: Jan. 16, 2007

(51) Int. Cl. H02P 7/00

(52) U.S. Cl. 318/135

(57) ABSTRACT

The present invention provides an integrated linear motor, which comprises a linear stage and a controller coupled to the linear stage, wherein the linear stage comprises a Hall sensor, an encoder, and a linear motor integrated thereon and the controller comprises a microprocessor, an amplifier, and a power supply integrated therein.

### BACKGROUND OF THE INVENTION

1. Technical Field

The present invention relates to linear motors and, more particularly, to a solution of integrated linear motor realized by integrating a modularized controller and a linear motor to a linear stage.

2. Description of Related Art

A conventional linear stage 100, as shown in FIG. 1, primarily comprises a foundation 2, a stator 3, a plurality of sliders 4, a pair of slide guides 5, a forcer 6, a forcer housing 7, and a position feedback system 8.

A typical servo control system 200, as shown in FIG. 2, primarily comprises a motor 20, an encoder 22 pertaining to the motor 20, a servo controller 25 and an amplifier 27 which are situated outside of the motor 20 and the encoder 22, and connected to the motor 20 and the encoder 22 by a plurality of transmission lines. The servo controller 25 comprises a power supply and a ground wire, and is connected to a computer 300 through a wire means. The amplifier 27 also comprises a power supply and a ground wire. The servo controller 25 and the amplifier 27 are further interconnected by means of a transmission suite 35 so as to transmit manifold directive and status signals. The encoder 22 and the servo controller 25 are interconnected through a plurality of transmission lines 37, such as a power cord, a ground wire and plural signal lines. The motor 20 and the amplifier 27 are interconnected through a plurality of transmission lines 39, such as a power cord for supplying power to a Hall sensor installed in the motor 20, a ground wire and plural signal lines.

As a command is generated from the computer 300, it is received by the servo controller 25 to be compared with a feedback signal generated by the encoder 22 for acquiring an error command that is used to regulate the output current of the amplifier 27 with particular control rules so that the motor 20 and stage 100 can realize the command in the aspect of position and speed.

All the modules depicted in FIG. 2 are independent components and interconnected through the complexly arranged external wires. Thereupon, risks of wire-misarrangement and noise disturbance that debase the reliability of the system can be significantly increased due to the complexity of the wire arrangement and the overlong lines. Additionally, costs and expense for wire preparing, wire arrangement, system repair and maintenance can be substantially raised for the complexity of the wire arrangement.

In FIG. 3, a typical wiring layout of the linear stage 100, servo control system 200 and the computer 300 are illustrated. Through the drawing, it is even more apparent that the external wiring of the linear motor system is extremely complicated.

### SUMMARY OF THE INVENTION

It is one objective of the present invention to provide an integrated linear motor, which is formed by integrating a linear motor and a servo control system into a mechanism and further assembling the mechanism to a linear stage wherein all transmission of control signals and data is accomplished by means of internal electric contacts instead of external electrical wiring. Thereby, the present invention is advantageous by reduced costs for wire preparing, wire arrangement, system repair and maintenance, space saving, mitigated risk of mal operation of the system due to noise disturbance, and enhanced reliability of the system.

To achieve these and other objectives of the present invention, the integrated linear motor comprises:

a liner stage having a Hall sensor, an encoder and a linear motor integrated thereon; and

a controller having a microprocessor, an amplifier, and a power supply integrated therein;

wherein the controller is coupled to the liner stage.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is an exploded view of a conventional linear stage;

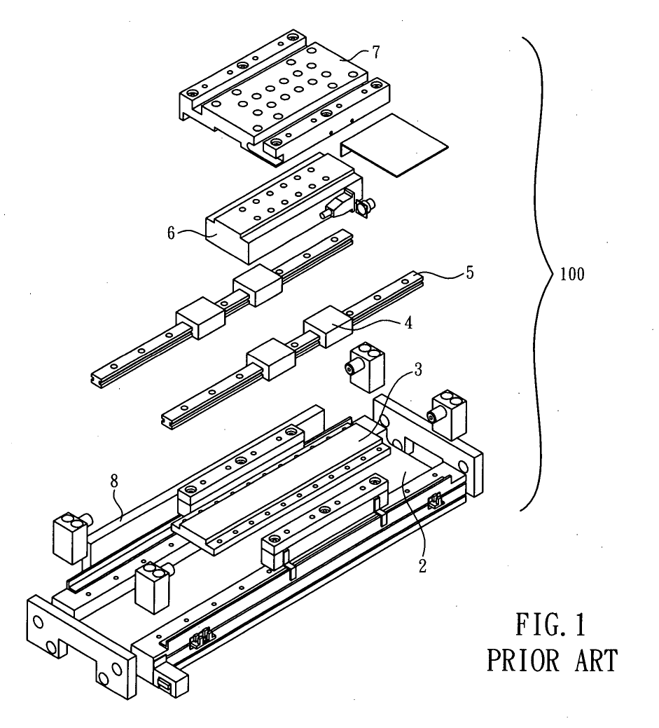

FIG. 2 is a component diagram of a conventional linear motor and a controller thereof;

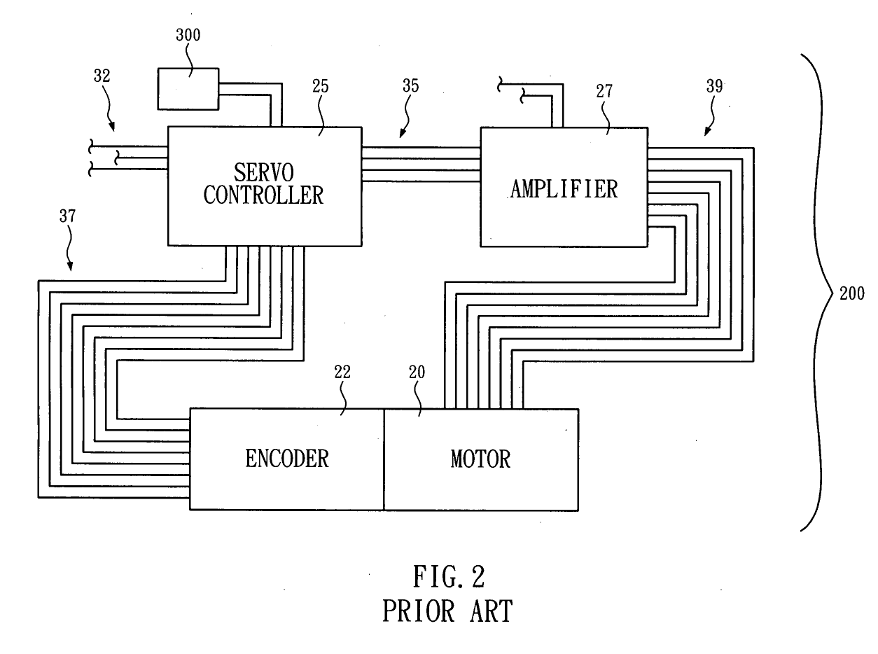

FIG. 3 is showing an exemplificative assembly of a conventional linear motor, a stage and a controller;

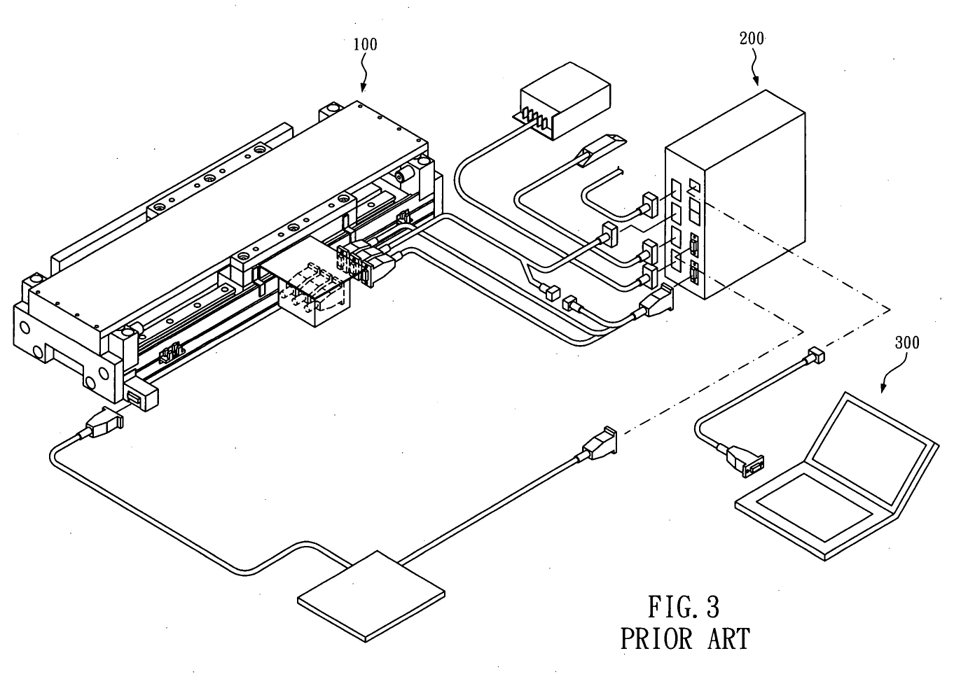

FIG. 4 is a component diagram of the modularized controller of the present invention; and

FIG. 5 is an assembly drawing of the modularized controller and a conventional linear stage according to one embodiment of the present invention.

### DETAILED DESCRIPTION OF THE PREFERRED EMBODIMENT

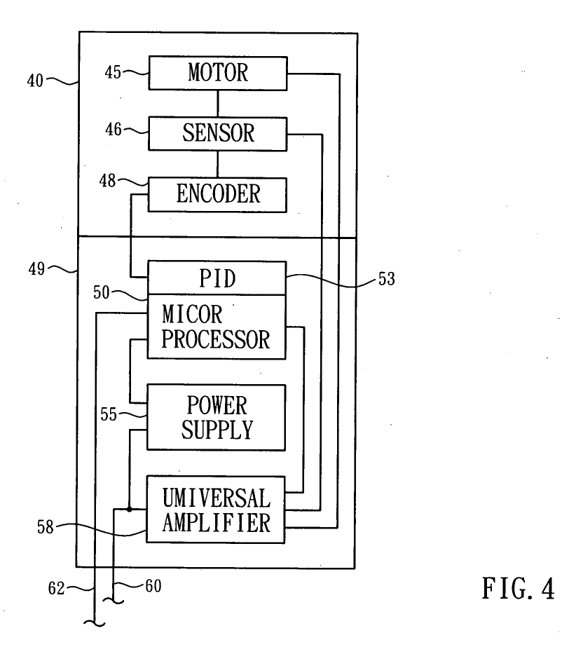

FIG. 4 graphically illustrates the system configuration of the integrated linear motor according to the present invention. As can be seen through the drawing, a Hall sensor 46, an encoder 48 and a linear motor 45 are integrated onto a stage 40. A microprocessor 50, an amplifier 58, a power supply 55 and a proportional integral derivative filter (PID filter) 53 are integrated in a controller 49 which is further coupled with the stage 40 by mechanical means. Direct current (DC) is provided to the controller 49 through a power input unit 60. Other formalized signal lines such as RS-232 are also provided to the controller 49 by way of a COM port 62.

The power input unit 60 is connected to the amplifier 58 and power supply 55 in the controller 49.

The power supply 55 functions for storing electric power and providing applicable direct current to other power demanded components of the controller 49. Signals are imported to the microprocessor 50 through the COM port 62 so as to switch on the linear motor 45. The position of the linear motor 45 is detected by the Hall sensor 46 and encoder 48 and the resultant position signals are to be transmitted to the microprocessor 50.

Through foresaid integrated configuration, the controller 49 is combined with the linear stage 40 in a modularized form wherein all transmission of control signals and data of the controller 49 is accomplished by means of internal electric contacts instead of complicated external electrical wiring.

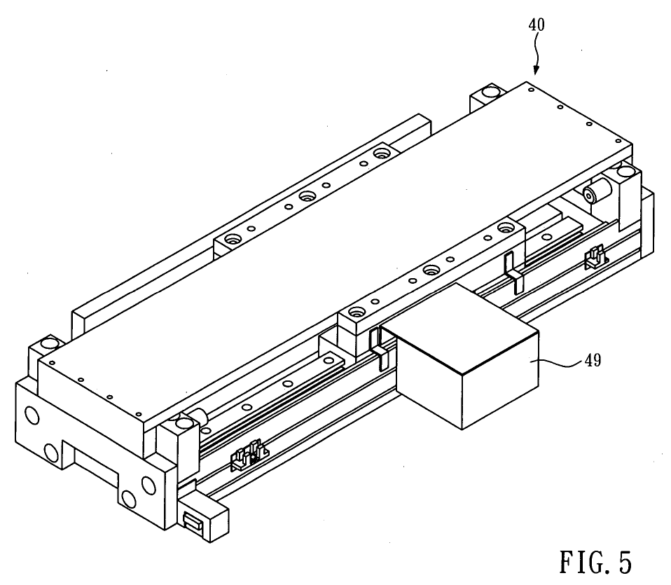

FIG. 5 is an assembly drawing showing the modularized controller 49 coupled with the linear stage 40 according to one embodiment of the present invention.

As a conclusion, by using the modularized controller of the present invention, all the external electrical wiring and lines of the servo system can be completely superseded by the internal wiring and electric contacts, and thereby the objective of reducing costs for wire arrangement, system repair and maintenance can be achieved. Meantime, as the number of the components of the system and wiring work are also curtailed in virtue of the disclosed modularized controller, and the integration of the linear motor and the linear stage, the entire volume of the system can be reduced and the risk of noise disturbance can be mitigated. Also, the integrated design of the controller, linear motor and linear stage facilitates retrenching the volume of the mechanism, enhancing regulating and positioning to the motor and improving control accuracy as well as reliability of the system.

Although a particular embodiment of the invention has been described in detail for purposes of illustration, it will be understood by one of ordinary skill in the art that numerous variations will be possible to the disclosed embodiments without going outside the scope of the invention as disclosed in the claims.

What is claimed is:

1. An integrated linear motor, which comprises:
a liner stage having a Hall sensor, an encoder and a linear motor integrated thereon; and
a controller having a microprocessor, an amplifier, and a power supply integrated therein;
wherein the controller is coupled to the liner stage.

2. The integrated linear motor of claim 1, wherein direct current is connected to the amplifier and a power supply in the controller by way of a power input unit.

3. The integrated linear motor of claim 1, wherein a plurality of formalized signal lines are connected to the microprocessor by way of a COM port.

4. The integrated linear motor of claim 1, wherein a proportional integral derivative filter is integrated with the controller.
